(19) United States
(12) Patent Application Publication
(10) Pub. No.: US 2008/0139439 A1
(43) Pub. Date: Jun. 12, 2008

(54) Cleaning and impregnating product

(76) Inventor: Winfried Weiss, Ried In Der Riedmark (AT)

Correspondence Address: DYKEMA GOSSETT PLLC, FRANKLIN SQUARE, THIRD FLOOR WEST, 1300 I STREET, NW, WASHINGTON, DC, 20005, US

(21) Appl. No.: 11/898,193

(22) Filed: Sep. 10, 2007

Related U.S. Application Data
(63) Continuation of application No. PCT/AT2006/000103, filed on Mar. 10, 2005.

(30) Foreign Application Priority Data
Mar. 10, 2005 (AT) GM 145/2005

(51) Int. Cl. C11D 3/20

(52) U.S. Cl. 510/240

(57) ABSTRACT

A method for cleaning and impregnating acid-resistant natural and artificial stones includes a single treatment of the surfaces of the stones with an acid-resistant protecting substance and an acid solution having a pH lower than 5.

A cleaning and impregnating product designed for acid-resistant natural and artificial stones, and method for cleaning and simultaneously impregnating acid-resistant natural and artificial stones

The present invention relates to a cleaning and impregnating product designed for acid-resistant natural and artificial stones, and method for cleaning and simultaneously impregnating acid-resistant natural and artificial stones and a chemical composition for cleaning and impregnating acid-resistant natural and artificial stones in one single operation. The invention is especially directed at the creation of a cleaning and care product which not only has conserving properties but is also suitable for the simultaneous removal of cement blooms, rust and similar impurities, and also as a rust converter or for roughing polished granite or limestone surfaces as well as glazed ceramic surfaces in order to increase security against slipping on wet surfaces.

After the installation, laying or production of building structures, parts of building structures or monuments made of mineral building materials, cleaning was performed with acid-containing or acidic cleaning agents, generally known as cement bloom or efflorescence removal agents, as rust removers or the like. Such impurities originate for example from processing with laying mortar, adhesive mortar or joint sealer. Impurities can also be obtained through efflorescence when calcium carbonates are dissolved from the base and are transported to the surface of the areas to be cleaned. Adhering impurities such as grinding and sawing sludge, rust and other acid-soluble impurities can be obtained by mechanical processing of the mineral building materials.

Employed acids or combinations of acids are for example hydrochloric acid, phosphoric acid, sulfamic acid, formic acid, citric acid or solutions of acid salts. Cleaning agents acting on the basis of such acids are known for example from DE 36 06 511 A, DE 34 32 581 A or JP 09-031493 A.

This solution inevitably also attacks the jointing of the stones which consists of cement, especially in cases when work is not conducted carefully and properly. Since it is generally necessary to always work in a planar manner, the joints will always suffer because the cement, as the bonding agent of the joint mortar, is dissolved superficially and is swept away when the floor is rinsed.

After such a treatment with a highly acidic cleaning agent, there is usually an aftertreatment with stone care agents which have an impregnating or coating property. This occurs by applying or introducing water and/or solvents which contain dissolved, emulsified or dispersed protective substances with a hydrophobic or lipophobic effect. Such protective substances are for example modified waxes, silanes, siloxanes, resins or polymers. They substantially prevent the penetration of humidity and/or greases or oils, and other impurities in that they seal the free surface pores slightly to completely and conversely also limit vapor diffusion accordingly.

Known agents of the kind mentioned above either have a strong cleaning effect or a distinctive protective function. Accordingly, it was necessary to date to work with two products for achieving cleaning and the protective effect.

Although there are stone care products on the basis of chlorinated hydrocarbons with additions of natural resins or waxes, especially in the form of waxes of polyvinyl ether, octadecyl alcohol and the like, such stone car agents are partly capable of also removing impurities and cement bloom. Their character is not acidic or only slightly so and are far from sufficient for cleaning the above-mentioned impurities. Many of them come with the disadvantage that they are hazardous or inflammable when used with other solvents. Moreover, the remaining protective film will soften under heat, so that the coating will gradually lose its gloss over time. It is further not dirt-repellent. Finally, such products also contain paraffin oil, leading to the risk of slippage on such smooth slabs.

Lacquer-like products are also already known with which the gloss of matted stones can be reproduced again. These products concern colorless lacquers in the widest sense which need to be applied with a brush, so that there is no cleaning effect whatsoever. Concerning inflammability or hazardousness to health, the same applies to these lacquer-like products as for the known stone care agents.

The state of the art further includes resin solutions or resin dispersions, optionally mixed with wax emulsions and wetting agents which are used for floor care. These products are not able however to remove cement bloom and strong impurities from stones which are caused by the action of grease, tar or oil.

The present invention is therefore based on the object of providing a chemical composition which has both a sufficiently favorable cleaning as well as impregnating effect in order to replace the previously required two processing steps by one single operation. This not only means a considerable reduction in the processing time, it is possible to omit the dwell time previously required between cleaning and impregnation which considerably delayed the completion of a building structure.

This object is achieved in such a way that an acid-resistant protecting substance or rendered acid-resistant is combined with acidic solutions, with the same both being present in a single product or even in two products which are mixed directly prior to their application in order to be applied in one operation on the substrate.

At the same time, the chemical composition in accordance with the invention may cause, if required, a rust conversion in the case of natural stones having a tendency to forming rust. For certain applications this chemical composition achieves a surface roughing in the case of polished granite, limestone with glazed ceramic or a similar substrate in order to achieve an improved anti-slip property.

It is also relevant for the invention to ensure a suitable balance between the acid percentage and the percentage on the additional substance. The additional substances are partly offered in a manner so as to be rendered acid-resistant but are not suitable as treatment agents in this form. It is necessary to produce dilution on the one hand in order to bring about the effect of the additional substance in a suitable form, and on the other hand it is necessary to reduce the pH-value in order to achieve the cleaning effect.

Below there are a number of examples for cleaning agents/impregnating agents in accordance with the invention which depending on composition are used especially as cement bloom removers, rust converters or rust removers, façade cleaners, disinfection cleaners or for roughing polishes surfaces. These details expressly also include all chemical preparations not falling under this patent.

### EXAMPLE 1

10 percentage by weight of phosphoric acid
3 percentage by weight of fluorinated polymer dispersion (e.g. the composition Dupont Zonyl 329)
87 percentage by weight of water

### EXAMPLE 2

10 percentage by weight of formic acid
3 percentage by weight of fluorinated polymer dispersion (e.g. the composition Dupont Zonyl 329)
87 percentage by weight of water

### EXAMPLE 3

10 percentage by weight of acetic acid
3 percentage by weight of a dispersion of alkyl alkoxysilane with polymers (e.g. the composition Wacker BS 29)
87 percentage by weight of water

### EXAMPLE 4

10 percentage by weight of phosphoric acid
3 percentage by weight of a dispersion of alkyl alkoxysilane with polymers (e.g. the composition Wacker BS 29)
0.1 percentage by weight of fluorinated surfactant (e.g. the composition Dupont Zonyl FSO)
86.9 percentage by weight of water

### EXAMPLE 5

10 percentage by weight of phosphoric acid
3 percentage by weight of a dispersion of alkyl alkoxysilane with polymers (e.g. the composition Wacker BS 29)
5 percentage by weight of polyvinyl alcohol
82 percentage by weight of water

### EXAMPLE 6

10 percentage by weight of phosphoric acid
3 percentage by weight of fluorinated polymer dispersion (e.g. the composition Dupont Zonyl 329)
0.1 percentage by weight of fluorinated surfactant (e.g. the composition Dupont Zonyl FSO)
86.9 percentage by weight of water

### EXAMPLE 7

10 percentage by weight of phosphoric acid
3 percentage by weight of fluorinated polymer dispersion (e.g. the composition Dupont Zonyl 329)
5 percentage by weight of polyvinyl alcohol
82 percentage by weight of water

### EXAMPLE 8

30 percentage by weight of phosphoric acid
10 percentage by weight of hydrochloric acid
2 percentage by weight of fluorinated polymer dispersion (e.g. the composition Dupont Zonyl 8740)
6 percentage by weight of mono-/diphosphoric acid ester (e.g. the composition BASF LUTENSIT A.EP)
1 percentage by weight of 2-butin-1,4-diol (e.g. the composition BASF Korantin BH rust inhibitor)
51 percentage by weight of water

### EXAMPLE 9

15 percentage by weight of acetic acid
2 percentage by weight of fluorinated polymer dispersion (e.g. the composition Dupont Zonyl 8740)
6 percentage by weight of mono-/diphosphoric acid ester (e.g. the composition BASF LUTENSIT A.EP)
77 percentage by weight of water

### EXAMPLE 10

15 percentage by weight of phosphoric acid
5 percentage by weight of sulphonic acid
3 percentage by weight of butyl diglycol (e.g. the composition Dupont Zonyl 8740)
6 percentage by weight of organofunctional silanes (e.g. the composition Degussa Protectosil SC)
67 percentage by weight of water

### EXAMPLE 11

30 percentage by weight of phosphoric acid
6 percentage by weight of cationic, biocidal tenside such as dimethyl-C12C14-alkyl benzyl ammonium chloride (e.g. the composition BASF Protectol KLC 50)
6 percentage by weight of low-foaming non-ionic tenside, such as fatty alcohol polyglycol ether (e.g. the composition BASF Plurafac LF 403)
2 percentage by weight of fluoroalkyl-functional, water-soluble polysiloxane (e.g. the composition Degussa Dynasylan F 8800)
2 percentage by weight of sodium hexametaphosphate
5 percentage by weight of isopropanol
48 percentage by weight of water

### EXAMPLE 12

10 percentage by weight of ammonium hydrogen difluoride
0.1 percentage by weight of fluorinated surfactant (e.g. the composition Dupont Zonyl FSO)
4 percentage by weight of fluoroalkyl-functional, water-soluble polysiloxane (e.g. the composition Degussa Dynasylan F 8800)
85.9 percentage by weight of water

1.-18. (canceled)

19. A cleaning and impregnating product designed for acid-resistant natural and artificial stones, consisting of a composition comprising an acid, with a pH lower than 5, said composition further containing a protecting substance which is acid-resistant or is rendered acid-resistant.

20. A cleaning and impregnating product according to claim 19, wherein the acid is present in an acidic solution and is an organic or inorganic acid or a solution of acid salts.

21. A cleaning and impregnating product according to claim 19, wherein the protecting substance contains a halogen polymer.

22. A cleaning and impregnating product according to claim 21, wherein the halogen polymer is present in a concentration of 1 to 10 percent by weight.

23. A cleaning and impregnating product according to claim 19, wherein the protecting substance contains a fluoropolymer.

24. A cleaning and impregnating product according to claim 19, wherein the protecting substance is an alkyl alkoxysilane.

25. A cleaning and impregnating product according to claim 24, wherein the alkyl alkoxysilane is present in a concentration of 1 to 10 percent by weight.

26. A cleaning and impregnating product according to claim 19, wherein the protecting substance contains a monosiloxane, polysiloxane or oligosiloxane.

27. A cleaning and impregnating product according to claim 26, wherein the monosiloxane, polysiloxane or oligosiloxane is present in a concentration of 1 to 10 percent by weight.

28. A cleaning and impregnating product according to claim 19, wherein the protecting substance contains a polyvinyl alcohol.

29. A cleaning and impregnating product according to claim 19, wherein the protecting substance contains a low-alkyl alcohol.

30. A cleaning and impregnating product according to claim 19, wherein the protecting substance contains a propanol.

31. A cleaning and impregnating product according to claim 19, wherein the protecting substance contains butyl glycol.

32. A cleaning and impregnating product according to claim 19, wherein the protecting substance is a combination of a halogen polymer, an alkyl alkoxysilane and a polyvinyl alcohol.

33. A cleaning and impregnating product according to claim 19, wherein the chemical composition additionally contains a tenside.

34. A cleaning and impregnating product according to claim 19, wherein the chemical composition additionally contains a rust preventing agent.

35. A cleaning and impregnating product according to claim 19, wherein the chemical composition additionally contains a complexing agent.

36. A method for cleaning and impregnating acid-resistant natural and artificial stones, wherein a chemical composition according to claim 19 contains a protecting substance which is acid-resistant or is rendered acid-resistant and an acidic solution whose pH is lower than 5.

37. A method according to claim 36, wherein the chemical preparation consists of at least two components, of which one contains the protecting substance, and the other contains the acidic solution, which are mixed with each other directly prior to application.

38. A method for cleaning and impregnating acid-resistant natural and artificial stones, wherein a chemical composition according to claim 19 contains a protecting substance which is acid-resistant or is rendered acid-resistant and an acidic solution whose pH is lower than 4.

39. A cleaning and impregnating product designed for acid-resistant natural and artificial stones, consisting of a composition comprising an acid, with a pH lower than 4, wherein the composition further contains a protecting substance which is acid-resistant or is rendered acid-resistant.
